(19) United States
(12) Patent Application Publication
(10) Pub. No.: US 2019/0255685 A1
(43) Pub. Date: Aug. 22, 2019

(54) NUT RUNNER TOOL

(71) Applicant: Mark Turner, Arlington, TX (US)

(72) Inventor: Mark Turner, Arlington, TX (US)

(21) Appl. No.: 16/279,208

(22) Filed: Feb. 19, 2019

Related U.S. Application Data
(60) Provisional application No. 62/632,769, filed on Feb. 20, 2018.

(51) Int. Cl. B25B 13/52; B25B 17/00

(52) U.S. Cl. CPC B25B 13/52; B25B 17/00

(57) ABSTRACT

A nut runner tool includes a housing having a drive gear and a plurality of guides. The drive gear is configured to receive a rotational drive input. The tool also includes a belt configured to engage the drive gear. The guides are positioned to guide oppositely-disposed portions of the belt toward each other to form a pear-shaped loop in the belt in a position exterior to the housing. The loop is engageable with a nut to cause rotation of the nut in response to the rotational drive input.

### BACKGROUND

In some mechanical assemblies, components are generally fastened together using nuts and bolts (e.g., via screw- or rotational-coupling via threads). Nut runner tools are configured to assist with the rotational coupling of nuts to bolts. For example, a nut runner may include a nut socket into which a nut, to be coupled to a bolt, is inserted. An actuating device is then used to rotate the nut socket to screw the nut onto the bolt. -couple the nut to the bolt.

### BRIEF SUMMARY

According to one aspect of the present disclosure, a nut runner tool includes a housing having a drive gear and a plurality of guides. The drive gear is configured to receive a rotational drive input. The tool also includes a belt configured to engage the drive gear. The guides are positioned to guide oppositely-disposed portions of the belt toward each other to form a pear-shaped loop in the belt in a position exterior to the housing. The loop is engageable with a nut to cause rotation of the nut in response to the rotational drive input.

According to another embodiment of the present disclosure, a nut runner tool includes a housing having a drive gear disposed therein and configured to receive a rotational drive input. A belt is configured to an hourglass shape having a first loop within the housing and engaging the drive gear and a second loop exterior to the housing. The second loop is engageable with a nut to cause rotation of the nut in response to the rotational drive input.

According to another embodiment of the present disclosure, a nut runner tool includes a drive assembly, a belt, and a guide assembly. The guide assembly engages an exterior surface of the belt to form the belt into the hourglass shape having a first loop and a second loop. An interior surface of the first loop engages the drive assembly and the drive assembly causes rotation of the belt in response to receiving a rotational drive input. An interior surface of the second loop is engageable with a nut to cause rotation of the nut in response to the rotation of the belt.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is a diagram illustrating a top, perspective view of an embodiment of a nut runner tool according to the present disclosure;

FIG. 2A is a diagram illustrating a front view of the nut runner tool of FIG. 1 according to the present disclosure;

FIG. 2B is a diagram illustrating an enlarged view of a portion of the nut runner tool of FIG. 2A engaging a nut according to the present disclosure; and

FIG. 3 is a diagram illustrating a side view of the nut runner tool of FIGS. 1, 2A, and 2B according to the present disclosure.

### DETAILED DESCRIPTION

Embodiments of the present disclosure provide a nut runner tool that is enables the rotational coupling (and de-coupling) of nuts to bolts. According to one embodiment, a nut runner tool includes a housing having a drive gear and a plurality of guides. The drive gear is configured to receive a rotational drive input. The tool also includes a belt configured to engage the drive gear. The guides are positioned to guide oppositely-disposed portions of the belt toward each other to form a pear-shaped loop in the belt in a position exterior to the housing. The loop is engageable with a nut to cause rotation of the nut in response to the rotational drive input. In some embodiments, the tool enables the rotation of a nut relative to a threaded bolt in limited access areas. For example, oftentimes, bolts may be located adjacent to walls or other structure such that there is limited access or space to secure a socket or other type of tool to the nut. Embodiments of the present disclosure enable a loop of a belt to be placed over the nut such that a space adjacent the nut can be as small as a thickness of the belt. The belt is then rotationally driven and engages the nut to rotate the nut relative to a threaded post or bolt.

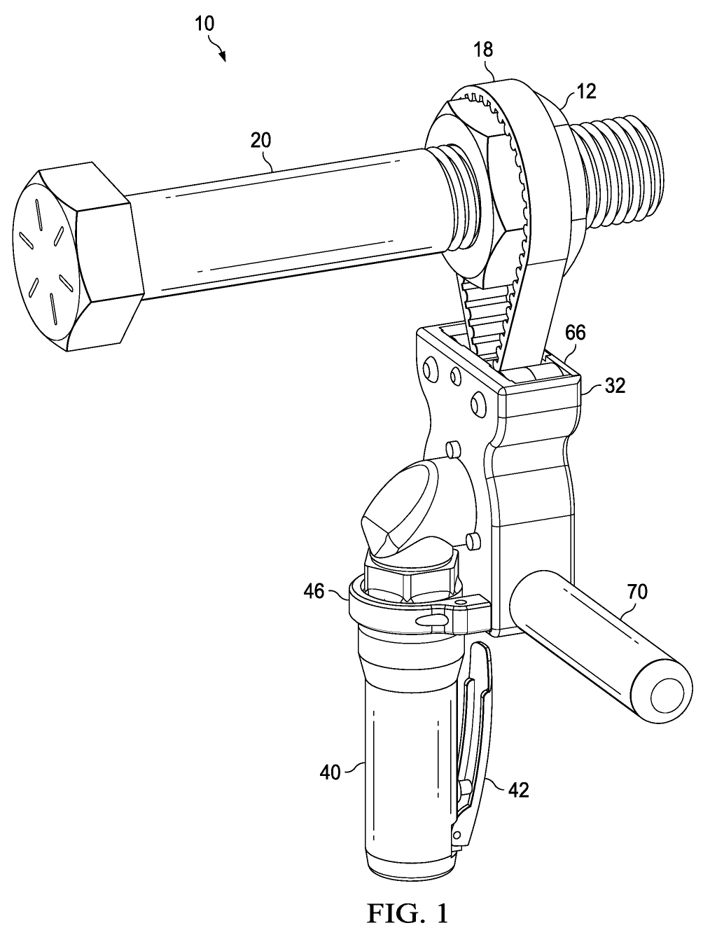

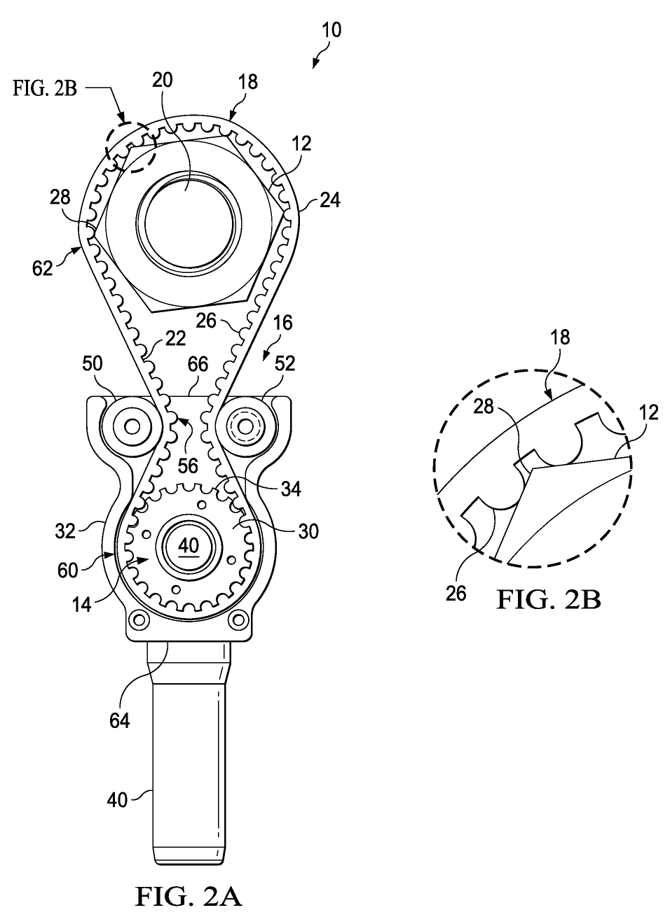

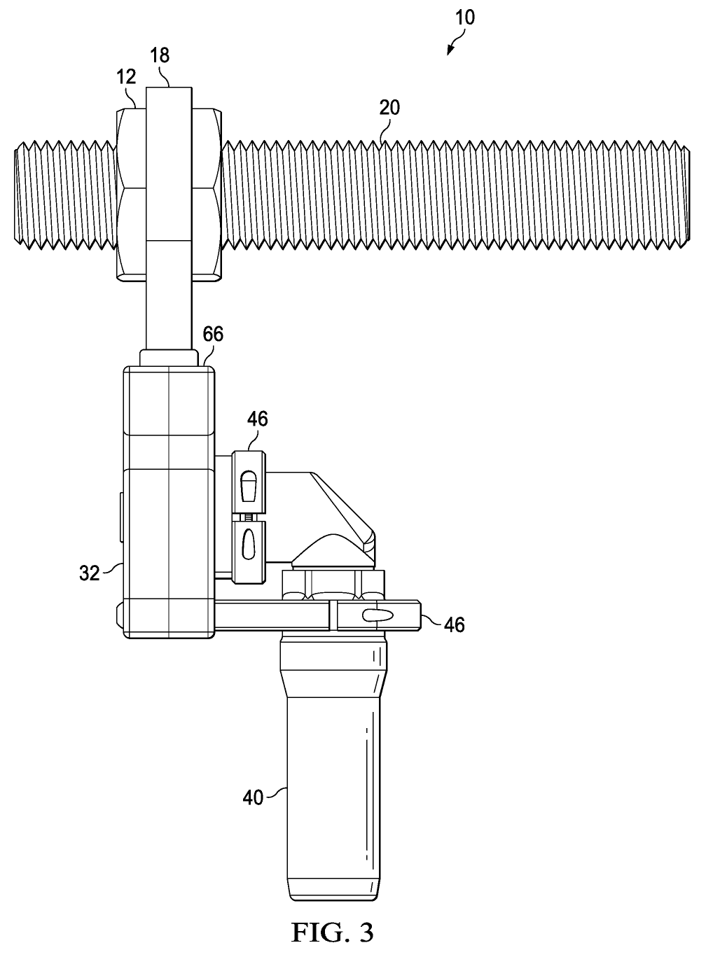

FIG. 1 is a diagram illustrating a top, perspective view of an embodiment of a nut runner tool 10 according to the present disclosure; FIG. 2A is a diagram illustrating a front view of the nut runner tool 10 of FIG. 1 according to the present disclosure; FIG. 2B is a diagram illustrating an enlarged view of a portion of the nut runner tool 10 of FIG. 2A engaging a nut 12 according to the present disclosure; and FIG. 3 is a diagram illustrating a side view of the nut runner tool 10 of FIGS. 1, 2A, and 2B according to the present disclosure.

In the embodiment illustrated in FIGS. 1-3, the nut runner tool 10 according to the present disclosure includes a drive assembly 14, and guide assembly 16, and a belt 18. Belt 18 is a flexible belt (e.g., a timing belt) that is engageable with the nut 12 and driven by the drive assembly 14 to cause corresponding rotation of the nut 12 relative to a threaded stud or bolt 20. For example, in the illustrated embodiment, belt 18 is generally a continuous loop of flexible material having an interior surface 22 and an exterior surface 24. The interior surface 22 of belt 18 includes notches or teeth 26 to engage the nut 12 (e.g., engage corners 28 of the nut 12) to apply a torque to the nut 12 to spin or rotate the nut 12 on or off the threaded stud 20.

In the illustrated embodiment, the drive assembly 14 includes a drive pulley or gear 30 rotationally coupled to and disposed within a housing 32. The drive gear 30 includes teeth 34 to engage teeth 26 of belt 18. In the illustrated embodiment, the drive gear 30 receives a rotational drive input by a drive device 40 removably couplable to drive gear 30, such as a right angle drill motor 42; however, it should be understood that other types of drive devices 40 could be used (e.g., any type of drill or device that provides a rotational output). It should be further understood that in some embodiments, a drive device mechanism may be incorporated into tool 10 as an integral unit (e.g., a battery powered motor to drive gear 30, etc.). In the illustrated embodiment, drive device 40 is removably coupled to housing 32 via one or more clamp fasteners 46; however, it should be understood that other types of fastening mechanisms may be used.

Guide assembly 16 is configured to enable an increased amount of torque to be applied to the nut 12 by the belt 18. For example, in the illustrated embodiment, guide assembly 16 includes guide rollers 50 and 52. In the illustrated embodiment, guide rollers 50 and 52 are rotationally coupled to and disposed within housing 32. In one embodiment, guide rollers 50 and 52 are disposed spaced apart from other and in alignment with each other relative to a distance to drive gear 30. Guide rollers 50 and 52 engage oppositely-disposed portions of the belt 18 on the exterior surface 24 of the belt 18 to create or form a necked-down or reduced-width medial region 56 of the belt 18. As best illustrated in FIG. 2A, guide rollers 50 and 52 cause oppositely-disposed portions of the belt 18 to be drawn inwardly toward each other, thereby forming an hourglass shape of belt 18. Thus, in the illustrated embodiment, the belt 18 has an interior loop 60 (i.e., disposed within housing 32) and an exterior loop 62 (disposed exterior to housing 32). In this embodiment, a distance between facing portions of the guide rollers 50 and 52 is less than a diameter or size of drive gear 30/loop 60 and less than a diameter or size of the loop 62 such that loops 60 and 62 are somewhat pear-shaped. As illustrated in FIG. 2A, housing 32 has a closed end near drive gear 30 and an open end 66 through which the belt 18 moves inward/outward relative to the housing 32. Thus, by forcing oppositely-disposed portions of the belt 18 inwardly as the belt 18 rotates inwardly/outwardly through the open end 66 of the housing 32, loops 60 and 62 nearly become closed, thereby enabling an additional amount of the belt 18 to engage drive gear 30 and nut 12, respectively (e.g., extending over a greater circumferential distance of the nut 12, such as over 180 degrees). Accordingly, guide rollers 50 and 52 cause a increased level of contact force between the belt 18 and the nut 12 to facilitate the transmission of torque to the nut 12.

As illustrated in FIG. 1, tool 10 may also include a handle 70. For ease of illustration and description, handle 70 has been omitted from FIGS. 2A and 3. It should be understood that tool 10 may also be configured without handle 70. Handle 70 may be used to increase or decrease a level of torque applied to the nut 12 by the belt 18. For example, in operation, loop 62 of the belt 18 may be placed over and in contact with the nut 12. Drive gear 30 may be rotationally driven (either clockwise or counter clockwise) by drive device 40 to obtain a corresponding desired direction of rotation of the belt 18. It should also be understood that if tool 10 is configured to have only a single rotational direction, tool 10 may be flipped over to facilitate rotation of the belt 18 in the opposite direction. With the belt 18 placed over and in contact with the nut 12, the drive device 40 may be actuated to cause the belt 18 to be driven/rotated, thereby imparting torque in a desired direction to the nut 12. A user may increase/decrease the level of torque imparted to the nut 12 by tool 10 by moving the tool 10 away/toward the nut 12, respectively, thereby increasing/decreasing the force applied to the nut 12 by the belt 18 (e.g., using handle 70 or by moving hosing 32).

Thus, embodiments of the present invention enable a flexible belt 18 to be fed into areas of limited access to engage a nut. For example, the belt 18 may be fed into limited access areas such that the flexibility of the belt 18 enables the belt 18 to be manipulated (e.g., by a user's hands or otherwise) to enable the belt 18 to be looped over a nut. The drive device 40 may then be actuated to cause the belt 18 to rotate relative to housing 32 and thereby imparting a torque to the nut. Embodiments of the present disclosure enable the loop 62 of the belt 18 to be placed over the nut 12 such that a space adjacent the nut 12 can be as small as a thickness of the belt 18. Thus, embodiments of the present disclosure facilitates the coupling or de-coupling of a nut relative to a threaded bolt or stud in areas where access to the nut 12 is extremely limited.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A nut runner tool, comprising:
a housing having a drive gear and a plurality of guides, wherein the drive gear is configured to receive a rotational drive input;
a belt configured to engage the drive gear, and wherein the guides are positioned to guide oppositely-disposed portions of the belt toward each other to form a pear-shaped loop in the belt in a position exterior to the housing, the loop engageable with a nut to cause rotation of the nut in response to the rotational drive input.

2. The nut runner tool of claim 1, wherein the belt is a flexible belt.

3. The nut runner tool of claim 1, wherein the belt has teeth for engaging the drive gear and the nut.

4. The nut runner tool of claim 1, wherein the guides are rollers.

5. The nut runner tool of claim 1, further comprising a handle coupled to the housing to facilitate drawing of the housing away from the nut to increase tension between the belt and the nut.

6. The nut runner tool of claim 1, wherein the guides are positioned relative to the belt to cause an hourglass-shape configuration of the belt.

7. The nut runner tool of claim 1, wherein the guides are positioned to cause a shape of the belt to have a necked-down medial region.

8. An nut runner tool, comprising:
a housing having a drive gear disposed therein and configured to receive a rotational drive input;
a belt configured to an hourglass shape having a first loop within the housing and engaging the drive gear and a second loop exterior to the housing, the second loop engageable with a nut to cause rotation of the nut in response to the rotational drive input.

9. The nut runner tool of claim 8, wherein the belt is a flexible belt.

10. The nut runner tool of claim 8, wherein the belt has teeth for engaging the drive gear and the nut.

11. The nut runner tool of claim 8, wherein an interior surface of the belt engages the drive gear and the nut, and further comprising a guide assembly disposed against an exterior surface of the belt to form the belt into the hourglass shape.

12. The nut runner tool of claim 11, wherein the guide assembly includes a pair of guide rollers.

13. The nut runner tool of claim 8, further comprising a handle coupled to the housing to facilitate drawing of the housing away from the nut to increase tension between the belt and the nut.

14. The nut runner tool of claim 8, further comprising a guide assembly coupled to the housing and configured to cause a shape of the belt to have a necked-down medial region.

15. A nut runner tool, comprising:
a drive assembly;
a belt; and
a guide assembly; and
wherein the guide assembly engages an exterior surface of the belt to form the belt into the hourglass shape having a first loop and a second loop, wherein an interior surface of the first loop engages the drive assembly, wherein the drive assembly causes rotation of the belt in response to receiving a rotational drive input, and wherein an interior surface of the second loop is engageable with a nut to cause rotation of the nut in response to the rotation of the belt.

16. The nut runner tool of claim 15, wherein the belt is a flexible belt.

17. The nut runner tool of claim 15, wherein the belt has teeth for engaging the drive assembly and the nut.

18. The nut runner tool of claim 15, wherein the guide assembly includes a plurality of spaced apart and adjacently disposed guide rollers.

19. The nut runner tool of claim 18, wherein a distance between facing surfaces of the guide rollers is less than a diameter of the first loop.

20. The nut runner tool of claim 15, further comprising a housing having an open end, wherein the first loop and the drive assembly are disposed with the housing, and wherein a remaining portion of the belt extends outward through the open end.
